(19) United States
(12) Patent Application Publication
(10) Pub. No.: US 2007/0185685 A1
(43) Pub. Date: Aug. 9, 2007

(54) Method and system in the maintenance of machines, processes, automation systems and equipment relating to papermaking

(76) Inventors: Petteri Lannes, Jokela (FI); Jari Tiitta, Kellokoski (FI); Jouni Pyotsia, Helsinki (FI); Tatu Pitkanen, Jarvenpaa (FI); Kaarlo Lackman, Tuusula (FI); Timo M. Pekkarinen, Tampere (FI)

Correspondence Address: STIENNON & STIENNON, 612 W. MAIN ST., SUITE 201, P.O. BOX 1667, MADISON, WI, 53701-1667, US

(21) Appl. No.: 10/598,392

(22) PCT Filed: Feb. 18, 2005
(86) PCT No.: PCT/FI05/50039

§ 371 Date: Oct. 26, 2006

(30) Foreign Application Priority Data
Feb. 27, 2004 (FI) 20040311

(51) Int. Cl. G21C 17/00

(52) U.S. Cl. 702/184

(57) ABSTRACT

A machine relating to papermaking is located at a production plant (100), which is equipped with a plant data system (155). A teleservice connection (189) based on a data communication link is arranged between the production plant (100) and a teleservice center (200). The condition, state and/or performance of the machine units and/or processes and/or automation systems of the production line at the production plant are monitored by monitoring systems, such as condition monitoring systems (130) and/or performance measuring systems (140) and/or quality assessment systems (150) and diagnostic units (110), in order to recognize emergency situations. An automatic service process is started in an emergency situation based on the signals given by the monitoring systems. The system includes means for bringing about the automatic service process.

### CROSS REFERENCES TO RELATED APPLICATIONS

This application is a U.S. national stage application of International App. No. PCT/FI2005/050039, filed Feb. 18, 2005, the disclosure of which is incorporated by reference herein, and claims priority on Finnish App. No. 20040311, filed Feb. 27, 2004.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention concerns a method and system in the maintenance of machines, processes, automation systems and equipment relating to papermaking, wherein the machine relating to papermaking is located in a production plant, which is equipped with a plant data system, and wherein is arranged a telemaintenance connection based on a data communication link between the production plant and the telemaintenance center, whereby the condition, state and/or performance capacity of the machine units and/or processes and/or automation systems of the production line in the production plant are monitored by monitoring systems, such as condition monitoring systems and/or performance measuring systems and/or quality assessment systems and diagnostic units, in order to recognize emergency situations.

The invention concerns machines and equipment relating to papermaking, which are, among others, the machines and equipment used for making and aftertreatment of, for example, pulp, tissue, paper and board. The invention relates especially to maintenance of these machines and equipment and to monitoring of their operation and to support of the production. The invention is applicable in the maintenance of all units and automation systems of said machines and equipment. The invention is examined especially in connection with the reel-up of a papermaking machine or a board-making machine or finishing equipment. Hereinafter, reference to this entity carrying out production and formed by machines and equipment relating to papermaking and finishing will be by the production plant concept.

The objective for maintenance operations and production support is to achieve maximum reliability of operation and performance at minimum costs. In this context, maintenance means the following sub-areas, among others:
pro-active maintenance, wherein such measurements and analyses relating to failure and wear are performed, with the aid of which preventive steps are taken to avoid the occurrence of failure,
predicting maintenance, which comprises condition monitoring and condition testing,
preventive maintenance comprising service at regular intervals,
customer support provided by the equipment supplier, which advises and gives guidance when required,
trouble-shooting performed as a teleaction, wherein the equipment supplier or other party to the service agreement performs trouble-shooting by utilizing telediagnostic systems of the fault diagnosis,
repairing steps proper, which are taken upon emergence of the failure,
documentation service, which may be, for example, an upkeep service for equipment documents maintained in a server outside the production plant, and
separate inspections, which are made, for example, in order to find out the wear of welded joints and machine structures.

Predicting and pro-active maintenance steps are based on online measurements and analyses, which are done to find out the condition of the equipment being examined. Vibration measurements and oil analyses are the most well known measurements diagnosing the condition of a papermaking machine. Almost all changes in machines and processes involved in papermaking affect the vibration properties of the equipment, and a change in a measured vibration level indicates that a change has occurred in the equipment. For example, in the case of a reel-up, bearing damage about to occur can be predicted with the aid of vibration measurements. In addition, uneven wear taking place in rolls and webs can be observed. Based on analyses of vibration data over a longer term it is possible to predict the optimum moment for exchanging machine components.

In connection with the maintenance, condition monitoring of machine units is performed, which is done with the aid of both automatic measuring systems and manual checks. Information available from the maintenance systems is collected both to the data systems of the place of installation and by teleupkeep to data systems of equipment suppliers.

According to the state of the art, many measurements relating to maintenance are made on a non-recurring basis, at regular intervals or when required, when a failure situation or a regular inspection has called for the measurement. Such individual measurements are, for example, vibration measurements of a papermaking machine's body structures, the results of which are examined with the aid of spectral or time plane analyses.

The equipment or another party in charge of the service, may also take telediagnostic steps in order to check the condition of a machine involved in papermaking. Preventive maintenance includes regular services, which are carried out under a service agreement or by separate order. In connection with a failure or a need for service, the customer orders service, for example, using a fax, by telephone or electronic mail.

A state-of-the-art maintenance system comprises several parallel and partly overlapping procedures, the management of which calls for profound knowledge of the operation of the production plant and its units. Information is collected with several methods into several different systems, some of which are electric/electronic, but not necessarily compatible, and some information may be stored in paper form only. Incompatibility of arrangements and human activity in the management of a complicated system increase the risk of occurring and prolonged interruptions in use.

### SUMMARY OF THE INVENTION

In the future, it is an objective for the maintenance of paper or board production plants to give up more and more the traditional maintenance methods in favor of pro-active and predictive maintenance, whereby predictive maintenance steps based on measurements are used to minimize the occurrence of failures and at the same time the losses resulting from breaks in the production.

It is an objective of the present invention to present a method and system in the maintenance of machines, processes, automation systems and equipment relating to papermaking, which method and system are used to control the maintenance by automatic service processes.

Another objective of the present invention is to present a method and system in the maintenance of machines, processes, automation systems and equipment relating to papermaking, which method and system can be used to make more effective the implementation of a pro-active maintenance.

An additional objective of the present invention is to present a method and system in the maintenance of machines, processes, automation systems and equipment relating to papermaking, wherein the data measured in condition monitoring is utilized more effectively than before.

An additional objective of the present invention is to present a method and system in the maintenance of machines, processes, automation systems and equipment relating to papermaking, with the aid of which the number of service breaks in the production plant is clearly reduced from the present level.

An additional objective of the present invention is to present a method and system in the maintenance of machines, processes, automation systems and equipment relating to papermaking, with the aid of which the performance of the production plant's machines and the relating parameters, such as process parameters, quality, machine speed, coefficient of efficiency of time and materials and production quantity, are followed more efficiently than before.

Another objective of the invention is to provide equipment and a method to bring about a quick video and audio connection between the production plant's operator and the telemaintenance center.

The method according to the invention is mainly characterized in that in an emergency situation an automatic service process is started based on signals given by said monitoring systems.

The system according to the invention for its part is characterized in that the system comprises means for providing an automatic service process.

According to the invention, the machine units of the production plant are monitored by a condition monitoring system, to which belong, for example, diagnostic units, which monitor in real time the operation of the machine units being measured. The signals measured by the units of the condition monitoring system and relating to the state and condition of the machine unit are collected into a data-collecting unit, which passes on data to a message relay system. In the trouble or emergency situation arisen, the message relay system automatically transmits to the teleservice center data concerning the state and condition of the equipment, and in the center the messages are automatically processed and analyzed. Based on the received data, the automatic service system at the teleservice center generates instructions for action, and the occurred trouble situation is put right based on these. The instructions for action may be, for example, an order for a spare part, a message to the serviceman, instructions in advance for the following regular service concerning exchange of a component or an adjustment in the machine unit to be carried out as a teleservice action.

According to the invention, all stages described above for getting instructions for action to put right a failure situation result automatically and are brought about by the entity formed by the condition monitoring system, the data-collecting unit, the message relay system and the teleservice center. After processing according to the invention, the automatically resulting completed instructions for action or action is transferred to the service staff for their information and to further processing. Hereby the present invention forms a maintenance entity collecting information constantly and reacting immediately and automatically, when an abnormal situation is detected in the operation of a machine unit at the production plant.

The present invention develops the known state-of-the-art maintenance system significantly by providing automatic instructions for action at stages, which traditionally have required active action by the service staff. A significant advantage of the invention is an improved predictability of the need for service and prompter steps to avoid predictable failure. The method and system according to the invention make sure that all stages relating to the automatic process according to the invention will be carried out and that all messages will reach their destination.

According to an advantageous additional embodiment of the invention, the control center of the production plant is equipped with an intelligent communication system, which sets up a prompt connection with the teleservice center or other such external quarter defined in the service agreement, which provides a constant maintenance service. Hereby the operator at the production plant can by a single act, for example, by pressing a key or a button, bring about a connection with the teleservice center when an unexpected failure situation occurs. For the connection, the operator's terminal is provided with an audio and video connection, whereby a videophone connection is established between the operator and the teleservice center. Communication face to face helps to clarify the failure situation in such cases, where the automatic diagnostic means do not give sufficient information about the occurrence or where personal and urgent additional guidance is needed in the situation occurred.

The present invention provides an overall system, with the aid of which emergency situations occurring at the production plant, such as trouble situations in equipment, can be handled as quickly as possible and the normal situation can be restored, where production works as it should and with optimum efficiency.

The invention is suitable for use anywhere at such a production plant or finishing plant to do with papermaking, which is in teleservice connection with a teleservice center and where the production equipment is provided with a condition monitoring system and with measuring units relating to this. The invention makes possible a better utilization than before for teleservice systems.

In the following, the invention will be described in greater detail by referring to the figures shown in the appended drawing, but the intention is not to restrict the invention narrowly to the details shown in the figures.

### BRIEF DESCRIPTION OF THE DRAWINGS

FIG. 1 shows an example of a service system for a production plant according to the invention.

FIG. 2 illustrates an automatic service process according to the method of the invention.

FIG. 3 is a presentation in flow chart form of an example in a situation where in accordance with the invention automatic instructions for action are provided for maintenance.

### DESCRIPTION OF THE PREFERRED EMBODIMENTS

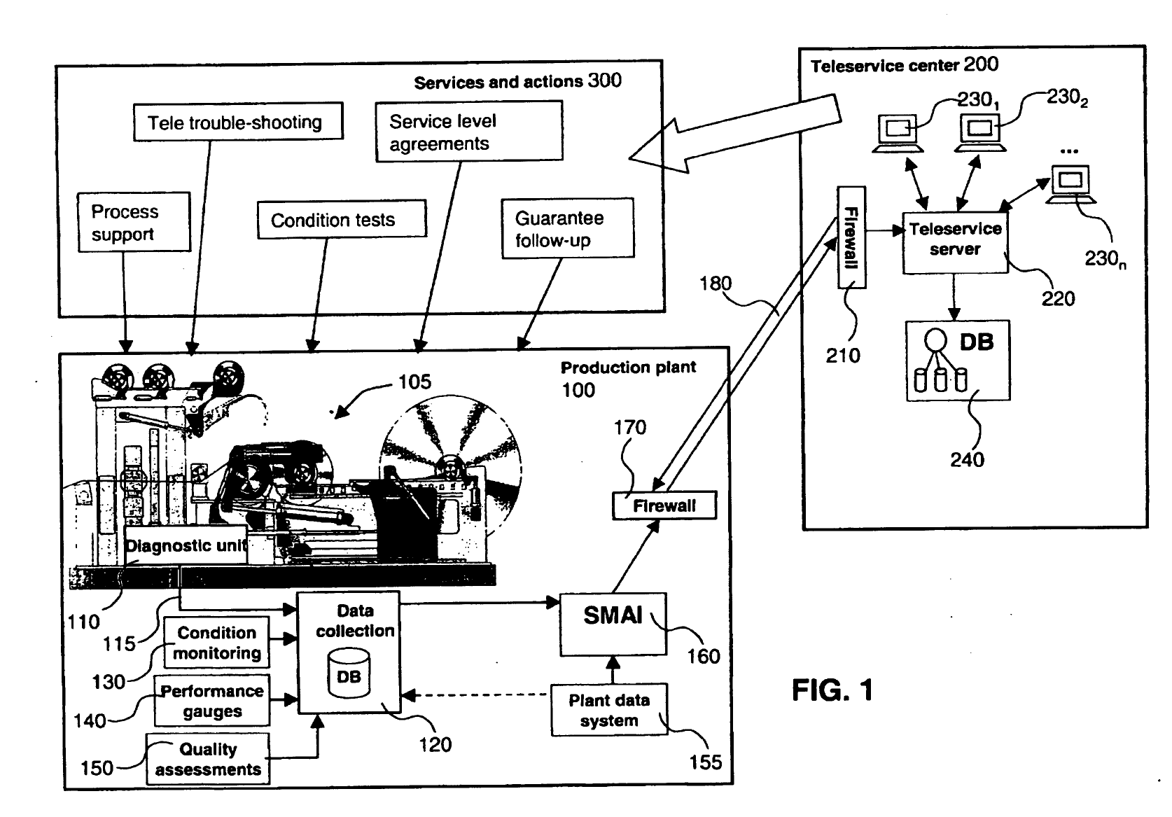

In FIG. 1, an example is shown of a production plant's maintenance system according to the invention, which production plant 100 comprises machines relating to papermaking, such as machine units of a papermaking machine or a boardmaking machine or a finishing machine. The invention is described with the aid of a reel-up unit 105, but the invention can be applied as well also to other machine units, such as, for example, the pulp manufacture, the short circulation, the headbox, the wire section, the press section, the drying section, the calender, the coating machine, the intermediate reel-up, the slitter-winder or the roller handling equipment.

In FIG. 1, the production plant's 100 reel-up unit 105 is equipped with one or more diagnostic units 110 belonging to a condition monitoring system. The diagnostic unit 110 is, for example, a data logger or a condition monitoring device or data collecting device monitoring the state of the reel-up unit 105. It may also be a process station in the automation system controlling the operation of the machine/process, or an intelligent measuring unit developed to meet the needs of the data collection, telediagnostics and embedded automatics of the condition monitoring. For example, the reel-up unit 105 may typically accommodate 1-10 diagnostic units 110 arranged to monitor the vibrations of the reel-up unit's 105 body structures and bearings, among other things.

The diagnostic unit 110 monitors the reel-up unit's 105 performance and condition and transmits data to the data-collecting unit 120 by way of a data link 115. The data-collecting unit 120 preferably receives data relating to the condition monitoring also from the production plant's condition monitoring unit 130, performance gauges 140 and quality assessments 150.

The data-collecting unit 120 comprises a database, wherein data collected from the diagnostic units 110 and from other condition monitoring systems are stored. Also other such data available from the production plant, which can be utilized for maintenance purposes, may be brought to the data-collecting unit 120. For each measured object and/or measured variable limit values are determined, which determine a permissible range of operation for said objects and variables, and these limit values are preferably stored in the data-collecting unit 120. When measured or defined data changes in such a way that the established limit value is exceeded or not reached, that is, when the measured value moves away from the permissible range of operation, the data-collecting unit 120 will send a triggering action of this to the message relay system, that is, to SMAI unit 160 (SMAI, Solution for Messaging and Application Integration). Alternatively, the SMAI unit 160 may constantly or at desired intervals receive data from the data-collecting unit 120 and will itself trigger, when the established limit value is exceeded. In both cases, the emergency situation, which has occurred, is noticed immediately in the system according to the invention.

The data-collecting unit 120 described above is an operational entity, which may be a separate unit comprising the required processor capacity for data processing and memory capacity as well as database functions for storing the information, or its functions may be included in connection with the units of the other condition monitoring system or in connection with the SMAI unit 160.

SMAI unit 160 (SMAI, Solution for Messaging and Application Integration) is a message relay system developed by Metso Paper, Inc., which comprises means for automation of service processes, that is, logics, making it react to abnormal signals received from the data-collecting unit 120 or to triggering actions caused by these. SMAI unit 160 hereby also receives information about which piece of equipment or which component has caused the triggering, and preferably also quantitative information relating to the failure or to any other emerging problem, for example, information about a change in the vibration level.

The message relay system, that is, the SMAI unit 160, is located at the production plant, for example, in connection with the other information systems or in some other suitable place, where data communication links can be arranged with the diagnostic units 110 and other condition monitoring systems on the one hand, and with the teleservice center 200 on the other hand. Necessary data communication links can be arranged along wires or without wires by applying technology known as such.

In an advantageous embodiment of the invention, SMAI unit 160 is also in connection with the production plant's 100 plant data system 155. The plant data system 155 collects, processes and keeps up information relating to the production follow-up and management of the production plant 100. Alternatively, the connection between the SMAI unit 160 and the plant data system 155 can also be arranged through the data-collecting unit 120 (dashed line in FIG. 1).

The messages sent by the SMAI unit 160 to the teleservice center 200 are preferably XML messages (XML, Extensible Markup Language) in a structured form, which comprise identifying information to tell from which production plant, from which machine unit, line etc. the message was sent, what problems or events have occurred and other data in use telling, for example, about the machine's operating point and its history of operation. Of such an XML message an example is presented below, wherein the meaning of the different message lines is told in parentheses by way of clarification (comments):

| | |
|---|---|
| <PowerMaintFailureReport > | {beginning of failure report } |
| <orderer>SMAI</orderer> | |
| <customer> | {customer's identifier data} |
| <siteName>ABC2</siteName> | |
| <millID>654321</millID> | |
| </customer> | |
| <productionLine>003</productionLine> | {identifier data of the |
| production line} | |

| | |
|---|---|
| <failure> | {identifier data of the failure |
| situation} | |

```
    <tagName>IP23553</tagName> {identifier data of the object}
    <tagDescription>Oil temperature</tagDescription>
    <value>120</value>
    <status>HIGH</status>
  </failure>
  <object>I P23553</object>
  <failureStart>2001-12-17T09:30:47-05:00</failureStart>
                        {time for triggering action of the failure
    situation }
</PowerMaintFailureReport>  {end of failure report }
```

In this example, the teleservice center receives a failure report from the production plant, the name of which (siteName) is ABC2 and the identifier number (millID) is 654321. The failure situation causing the triggering action arose on the production line (productionLine) 003 and a more exact object identifier (tagName) is IP23553. The measured magnitude (tagDescription) “Oil temperature”, that is, the oil temperature, has changed to a value, which has exceeded the determined limit value, whereby the status of the measured object has turned into a high value (HIGH). In addition, the message contains information about the moment when the triggering action relating to the failure situation started (failureStart). Last in the message is a command to end the failure report, whereby the receiving server at the teleservice center will recognize that the message has ended.

The connection between SMAI unit 160 and teleservice center 200 preferably is by way of firewalls 170, 210 and it is preferably a protected Internet connection or a data communication link formed in some other known manner known as such. In the example shown in FIG. 1, the data leaving SMAI unit 160 travels through a firewall 170 located in the production plant along a two-way data communication link 180, and in the teleservice center 200 the data is taken through a firewall 210 to the teleservice center's 200 teleservice server 220.

The following is a presentation in greater detail of the location of the diagnostic units 110 shown in FIG. 1 in connection with a machine relating to papermaking and their operation. Magnitudes to be observed are, among others, alarms, I/0 signals, process parameters, laboratory measurements, quality assessments, performance measurements and condition monitoring measurements.

Using the diagnostic units 110 located in reel-up 105 it is possible to observe the following objects, among others:
motion times, frictions, vibration etc. indicating the mechanic condition,
performance of the reel-up, such as the roller exchange reliability percentage, durations of web feeding, broke percentage, and
availability level (coefficient of time and efficiency).

As a practical example of a situation where the system and method according to the invention are utilized the following may serve, where the system is used to follow broke quantities. If the quantity of broke exceeds the limit level, a message is generated in the SMAI unit and the message goes to the maintenance data system in the teleservice unit. Then a process support service is started, with which the process is set back to the operating point. All these stages take place in real time and the messaging is brought about automatically in the system according to the invention. In state-of-the-art systems, broke has time to form over a long time in a corresponding situation, when people try to cope with the situation by making telephone calls or by using other such methods of communication. Putting things right will hereby take a long time, much human labor is needed and plenty of costs will be incurred.

In the teleservice center 200 shown in FIG. 1, the data relating to a failure situation, which is received from the production plant's 100 SMAI unit 160, is processed in the teleservice center's data systems, which are provided with means for analyzing said data and for bringing about automatic instructions for action. The teleservice center 200 comprises a firewall 210 to ensure information security for its data systems and a teleservice server 220, which communicates with quarters relating to the teleservice system.

In the example shown in FIG. 1, the teleservice server 220 is in connection with a database 240 storing, for example, data relating to the maintenance of different production plants, and also with computer terminals 230₁, . . . ,230ₙ of the teleservice. The computer terminals 230₁, . . . ,230ₙ of the teleservice may be physically located at the teleservice center 200 or outside the teleservice center 200. According to the invention, the teleservice server 220 or other equivalent data system of the teleservice carries out an analysis automatically on the data arriving from the production plant 100 and relating to a failure situation and it automatically brings about instructions for action to remedy the failure situation. Upon completion of the instructions for action these can be read, for example, on the computer terminals 230₁, . . . ,230ₙ of the teleservice or they can also be printed out automatically. Besides teleservice matters proper, other functions may also be controlled, such as accountancy, invoicing etc. of the economic administration.

Based on the instructions for action, instructions are given for service actions to the staff at the production plant or at the teleservice center. According to FIG. 1, services and actions 300 may be, for example, process support, tele troubleshooting, condition tests, service level agreements and guarantee follow-up and trouble-shooting, remedy of failure, service agreements and spare part deliveries. Data collected by the system according to the invention can be stored in a database and used for implementing benchmarking or other consultancy services.

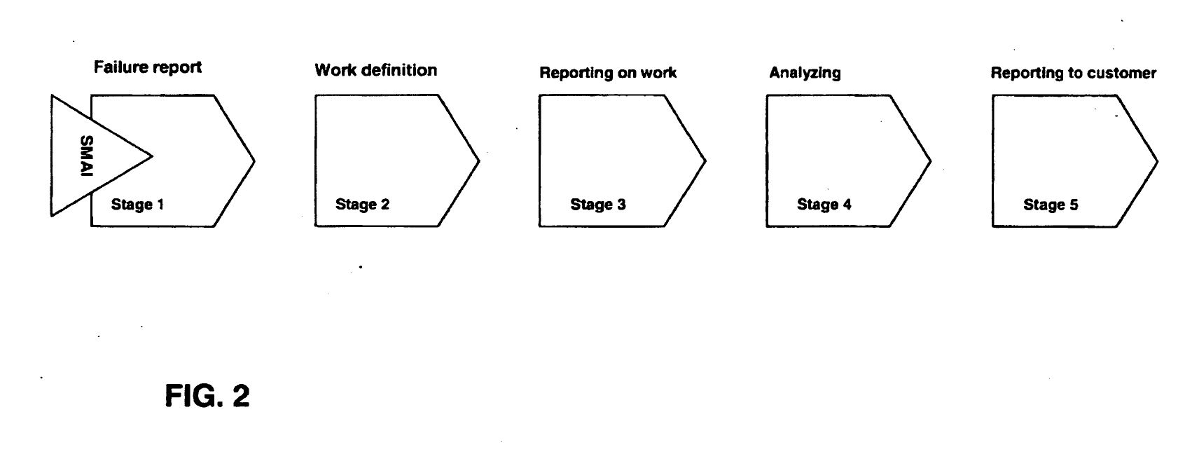

FIG. 2 illustrates the origin and development of a service process according to the invention. Stage 1 was preceded by a situation where exceeding of the limit value was detected in the measured value in the database of the data-collecting unit. This causes a change of state as regards said measured value in the database and a call for the SMAI procedure, which call is relayed to the SMAI unit. The SMAI unit starts a service process at stage 1 by generating and sending a failure report, for example, as an XML message of the kind described above, to the teleservice center, where the failure report is received. At stage 2 a work definition is carried out in the data system of the teleservice center to define, for example, at which time the work will begin, who will do the work, what materials, spare parts and instructions are needed. The work definition is delivered to the person doing the work, for example, by sending it in a wireless manner to the serviceman's PDA equipment or as an electronic mail message.

At stage 3 the person doing the work reports that the work is done and states what spare parts he has used as well as other information relating to the work performed. Reporting is preferably performed over a wireless communication link from the serviceman's PDA equipment to the teleservice center, whereby the information is stored directly in the data system of the teleservice center. The data system of the teleservice center hereby acknowledges that the work has been performed.

At stage 4 an automatic analysis step is carried out, wherein the occurred failure situation, the actions relating to it and other information are stored in a database. Thus it can be utilized later when planning preventive maintenance. At stage 5 a report finally results for the customer (the production plant), which report contains information about the occurred failure situation and about its impact on the production. The report is sent to the production plant preferably in electronic form.

The maintenance system according to the invention is preferably arranged as a spatial system. The system hereby functions in such a way that it ensures that all messages will reach their destination and all defined stages will be carried out.

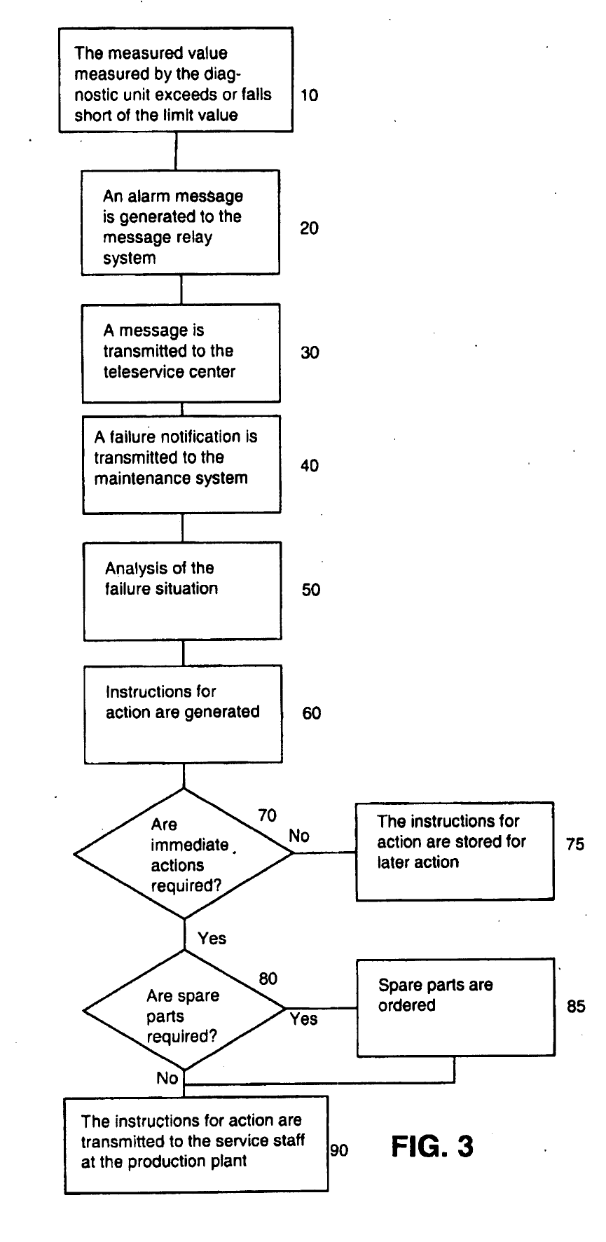

In FIG. 3, shown in the form of a flow chart, is an example in greater detail of a situation where automatic instructions for action according to the invention are provided for the maintenance. At stage 10 it is found in the diagnostic unit or other measuring unit that the measured value has transferred away from the determined permissible range. A triggering signal hereby results, which is transmitted to the message relay system, that is, to the SMAI unit. Such a transfer may be, for example, an increase in the vibration value measured from the machine body or a change in the friction level, in the time of motion, in the pressure difference, in the power level, in the load, in the quality, in the performance index, in the oil grade, in the coefficient of efficiency or in other such. At stage 20 an alarm signal is generated to the message relay system, which sends further the message about the occurred situation to the teleservice center at stage 30. At stage 40 a failure report is sent to the maintenance system. At stage 50 the occurred situation is analyzed automatically in the teleservice center. To aid in the analysis, such data can be used, which has been measured earlier on a similar object at other production plants or in the same production plant.

At stage 60 automatic instructions for action according to the invention are generated. The instructions for action may be, for example, a command to the operators of the production plant to change the operating parameters for the machine to be such that the part, of whose future breaking the change in measured vibration values predicted and caused the alarm, will keep in an operating condition until the next regular service. For example, in the case of a reel-up, examples of operating parameters to be changed could be, for example, a slower running velocity or running of smaller rollers. By such temporary actions the necessary service action can be put off or extra service steps or unplanned standstills can be avoided.

At stage 70 an assessment is made of whether immediate actions are needed in the failure situation or whether actions can be put off in the manner described above. If an action can be postponed, it is stored for later actions at stage 75, for example, to be taken in connection with the following regular service, or it is combined with some other future service visit.

If service is needed immediately, a check is made at stage 80, of whether spare parts are needed to do the service. If no spare parts are needed, the procedure moves on directly to stage 90, where the instructions for action are sent automatically to the service staff or to the production plant so that service will be arranged. If spare parts are needed, the next stage is stage 85, where an automatic spare parts order is generated, and the procedure then moves on to stage 90.

The entire chain of action described above is brought about automatically with the aid of the system according to the invention, wherein information is transferred from the measuring system to the message relay system and thence further to the data systems of the teleservice center. Stages 10-85 are carried out according to the program, and not until stage 90 is information transferred to the staff, for example, in the form of an electronic mail message, a printed report or a notification shown on a computer display or in some other suitable form. If the failure situation has occurred during the evening or night, the instructions for action will be waiting ready for use at once in the morning as the work shift begins and immediate service actions can be taken. Thanks to such a way of action according to the invention the failure situation can be remedied in a significantly shorter time.

In an advantageous embodiment of the invention, the control room or other operating place of operators at the production plant is provided with an audio and video connection and with means for taking contact, by which a videophone connection is provided between the operator and the teleservice center. The means for taking contact is, for example, a key or a button connected close to the operator, for example, mounted to the control desk. The means for taking contact may also be a virtually implemented key on the operator's monitor. The connection is preferably established on the same data communication route as the other contact keeping between the production plant and the teleservice center. When the operator at the production plant has noticed such a problematic situation, which can only be put right by speedy service consultation with the service staff, help is thus obtained immediately according to the invention to put the situation right. With this advantageous embodiment of the invention the present invention presents a maintenance solution, which ensures immediate service actions in all situations.

The invention was described in the foregoing by referring only to some advantageous embodiments of the invention, but the intention is not to restrict the invention narrowly in any way to the details of those embodiments. Many modifications and versions are possible within the scope of the inventive idea defined in the following claims.

1-20. (canceled)

21. A method in the maintenance of machines, processes, automation systems and equipment relating to papermaking, wherein a teleservice connection based on a data communication link is arranged between a production plant and a teleservice center, and wherein the machine relating to papermaking is located at a production plant which is equipped with a plant data system, and wherein the condition, state and/or performance of the machine units and/or processes and/or automation systems of a production line at the production plant are monitored by monitoring systems in order to recognize emergency situations,
in which method in a recognized emergency situation an automatic service process is started based on signals given by said monitoring systems, and
wherein the method functions statefully, whereby the method ensures that all stages will be carried out and that all messages will reach their destination.

22. The method of claim 21 wherein the monitoring systems comprise condition monitoring systems and/or performance measuring systems and/or quality assessment systems and diagnostic units.

23. The method of claim 21, wherein said automatic service process is started when the value of measured data collected from the monitoring systems exceeds or falls shorts of an established limit value.

24. The method of claim 21, wherein based on said automatic service process instructions for action and/or an action are formed automatically in order to remedy failure situations at the production plant.

25. The method of claim 21, wherein the automatic service process comprises stages, in which
for magnitudes measured/determined by the monitoring systems limit values are established, and any exceeding or falling short of these will cause a triggering signal;
in the production plant a data collecting unit is arranged, which receives the signals/measured data arriving from the monitoring systems and stores them in a database;
a message relay system is arranged at the production plant to receive the signals arriving from the data-collecting unit, which signals comprise triggering signals and measured data;
based on said signals and/or said triggering signals a failure situation is defined as having occurred;
a data communication link is arranged between the message relay system and the teleservice center;
in a failure situation, an automatic failure report is transmitted to the teleservice center by using said data communication link;
the failure situation is analyzed automatically at the teleservice center; and
based on the analysis, instructions for action are generated automatically to remedy the failure situation.

26. The method of claim 21, wherein a data communication link is arranged between the message relay system and the plant data system.

27. The method of claim 21, wherein at the stage where the failure situation is analyzed, data measured earlier on the same or a similar object is utilized in the analysis.

28. The method of claim 24, wherein in the instructions for action an instruction is proposed concerning adjustment of operating parameters of the machine.

29. The method of claim 28, wherein the operating parameters of the machine are adjusted in such a way that the service action can be put off.

30. The method of claim 28, wherein the operating parameters of the machine are adjusted in such a way that the service action can be put off until the following regular service.

31. The method of claim 24, wherein the automatically generated instructions for action are delivered as an automatic message to service staff of the teleservice center and/or to service staff of the production plant.

32. The method of claim 24, wherein said automatically generated instructions for action and/or said action for remedying failure situations at the production plant comprise a control action, by which parameters of the production plant's machine unit are adjusted automatically.

33. A system in the maintenance of machines, processes, automation systems and equipment relating to papermaking, where the machine relating to papermaking is located at a production plant which is equipped with a plant data system, and wherein a teleservice connection based on a data communication link is arranged between the production plant and the teleservice center, and where the condition, state and/or performance of machine units and/or processes and/or automation systems of a production line at the production plant are monitored by monitoring systems, in order to recognize emergency situations, which system comprises means for providing an automatic service process, wherein the system is stateful whereby the system functions in such a way that all messages will reach their destination and all defined stages will be carried out.

34. The system of claim 33 wherein the monitoring systems comprise condition monitoring systems and/or performance measuring systems and/or quality assessment systems and diagnostic units.

35. The system of claim 33, further comprising means for providing automatically generated instructions for action.

36. The system of claim 33 further comprising:
means for collecting automatic measured data from the machine units of the production plant;
means for transmitting the measured data from the production plant to a teleservice center;
means for analyzing the measured data at the teleservice center;
means for generating automatic instructions for action at the teleservice center; and
means for transmitting the automatic instructions for action to inform service staff.

37. The system of claim 33 further comprising:
a data-collecting unit arranged to collect and store data arriving from the monitoring systems; and
a message relay system adapted to receive triggering signals and data arriving from the data-collecting unit and/or itself to form a triggering signal.

38. The system of claim 37 wherein a data communication link is arranged between the message relay system and the plant data system.

39. The system of claim 37 wherein the message relay system is arranged to form and transmit messages in a structured form.

40. The system of claim 39 where the message relay system is arranged to transmit messages in XML form.

41. The system of claim 39 wherein the messages formed by the message relay system are encrypted or protected in some other manner.

42. The system of claim 33 further comprising means for generating a video and audio link between the production plant and the teleservice center.

43. The system of claim 42 wherein the means for generating a video and audio link between the production plant and the teleservice center comprises a quick-acting key, which is arranged to open a direct data transmission link without any essential delay between the operator at the production plant and the staff at the teleservice center, as well as the means required for the data transmission link.
